(19) United States
(12) Patent Application Publication
(10) Pub. No.: US 2013/0215083 A1
(43) Pub. Date: Aug. 22, 2013

(54) SEPARATING AND SECURING OBJECTS SELECTED BY EACH OF MULTIPLE USERS IN A SURFACE DISPLAY COMPUTER SYSTEM

(71) Applicants: Barry Alan Kritt, Austin, TX (US); Thomas S. Mazzeo, Austin, TX (US); Sarbajit Kumar Rakshit, Kolkata (IN); Shawn Konrad Sremaniak, Austin, TX (US)

(72) Inventors: Barry Alan Kritt, Austin, TX (US); Thomas S. Mazzeo, Austin, TX (US); Sarbajit Kumar Rakshit, Kolkata (IN); Shawn Konrad Sremaniak, Austin, TX (US)

(73) Assignee: INTERNATIONAL BUSINESS MACHINES CORPORATION, Armonk, NY (US)

(21) Appl. No.: 13/400,286

(22) Filed: Feb. 20, 2012

(51) Int. Cl. G06F 3/042

(52) U.S. Cl. 345/175

(57) ABSTRACT

Separating and securing the input of any user to a multiuser surface display computer by storing a fingerprint of each of a plurality of users and sensing the fingerprint of a finger of a user touching, or adjacent to, the surface display. The sensed fingerprint is compared to stored fingerprints for a match and the identified (id) finger of a matched fingerprint is enabled to access the surface display and moved to draw an enclosure on the surface display and moved further to drag and drop a plurality of objects on the display into the enclosure. The enclosure and plurality of objects are then stored and subsequent access is limited to the fingerprint of said (id) finger touching said display.

### TECHNICAL FIELD

The present invention relates to surface display computer systems accessed and used by multiple users, and more particularly to separating and maintaining sets or groups of objects secure from other users.

### BACKGROUND OF RELATED ART

A surface computer is a computer that interacts with the user directly from the surface of the computer display rather than through a keyboard or mouse with a display monitor. The surface display of a surface computer is multiple touch unlike the iPhone™ or iPad™ that are restricted to single users, the surface computer can accommodate multiple users through a table size display.

Also, unlike the iPad that uses the electrostatic properties of the user's finger to detect touch and movement, the surface display computer uses an infrared multi-camera array to detect fingers and other objects placed anywhere on the display surface.

Display surface computers typically have a relatively large surface, 30 inches or more diagonally, with a XGA DLP projector under the surface casting the surface image onto the underside of the surface. About 5 or 6 cameras in the housing record the reflections of infrared light from objects including fingers on or adjacent to the surface. Thus, the surface can recognize fingers and other objects, as well as their orientation. Of course, finger movements can be tracked.

The surface display computer is multi-touch from multiple users. The display has the capability of tracking and responding to over 50 simultaneous touches. A single user can use all ten fingers simultaneously. Surface display computers are used in business situations in which many user-intuitive environments need to input and output data into the computer system in a user-friendly manner. Applications have been used in stadium and theater events ticketing and admission control, hotel, casino and air-line functions.

With such multiuser input/output (I/O) surface display computers, there is a need to enable user-friendly access to a large group of users and yet retain the capability for the selected individual users of separating a group of objects from the display and securing the group for the exclusive use by a designated user.

### SUMMARY OF THE INVENTION

The present invention provides a solution for the need for enabling user-friendly access to a large group of users and yet retaining the capability for selected individual users to separate a group of objects from the display and secure the group for the exclusive use by a designated user. The present invention offers its solution from two perspectives based upon the purpose of the surface display computer system.

A. Where the system needs to enable a great many people to have access to the display I/O but have a smaller select group with access to secure functions.

B. Where the system is already limited to a group of identifiable users but still needs to provide individual users with the ability to separate and secure a selected set of displayed objects for a particular user.

Accordingly, the present invention addresses an optically sensed multi-touch input surface display computer system, such as an infrared sensing system, and provides a method for separating and securing the input of any of the multiple users that comprises storing at least one fingerprint of each of a plurality of selected users and sensing the fingerprint of a finger from a user touching, or adjacent to, the surface display. Then the sensed fingerprint is compared to the stored fingerprints for a match and the identified (id) finger of a matched fingerprint is enabled to access the surface display.

Then, the (id) finger may be moved to draw an enclosure on the surface display and moved further to drag and drop a plurality of objects on the display into the enclosure. The enclosure and plurality of objects are then stored and subsequent access to said stored enclosure and plurality of objects is limited only to the one user responsive to the fingerprint of the (id) finger touching the display.

The advantage of the present invention is that only one fingerprint of the user may be stored and have a stored (id) in association with the enclosed group of objects. Thus, when the user puts his five or even ten fingers anywhere on the display, the infrared multi-camera system is capable of identifying the significant fingerprint, wherein the access and draw enclosure functions are enabled.

In accordance with another aspect of this invention, a finger of a user is enabled to access the surface display prior to the sensing of the fingerprint of the finger and, thus, the finger can draw the enclosure and drag and drop the objects into an enclosure prior to the sensing of the fingerprint of the finger. The user can select to exclusively store the enclosure and the plurality of objects. The fingerprint of the user is then sensed and stored in association with the enclosure when the user selects to exclusively store. The subsequent access to the stored enclosure is enabled to the user only upon a match of the fingerprint of a user finger seeking access with the stored associated fingerprint.

The stored enclosure of objects may be hidden from the surface display until accessed through the fingerprint match.

Also, responsive to the access to the enclosure through the specific fingerprint match, all of the fingers of the user may be enabled to access the plurality of objects in said enclosure.

In accordance with another aspect of the invention, a plurality of users are enabled to form a corresponding plurality of enclosures of objects respectively subsequently accessible to the user by said fingerprint matches.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a simplified view of a surface display computer screen surface illustrating the relationship of a user's hand with the fingerprint of an identifiable (id) finger with objects on the display screen;

FIG. 2 is the view of FIG. 1 at a stage wherein the user finger is drawing an enclosure;

FIG. 3 is the view of FIG. 2 at a stage wherein the user finger is dragging user selected objects into the enclosure;

FIG. 4 is a view like that of FIG. 3 at a subsequent stage when the user enclosure and selected objects have been stored and hidden from the display surface and a user finger is seeking access;

FIG. 5 is an illustrative flowchart describing the setting up of the process of an embodiment of the present invention, wherein an identification of the user finger is made prior to permitting any access to the display surface;

FIG. 6 is an illustrative flowchart describing the setting up of the process of an embodiment of the present invention, wherein a user may access the display screen before identification of the user finger is made, but such identification is made associated with the enclosure of objects that the user wishes to exclusively store;

FIG. 7 is a flowchart of an illustrative run of the process setup in FIG. 5; and

FIG. 8 is a simplified block diagram of a surface display computer system on which the present invention may be implemented, including a computer central processing unit, RAM, storage, operating system and programming, as well as the surface display projector, IR cameras for sensing and capturing images of fingers and other devices adjacent to the display surface.

### DETAILED DESCRIPTION OF THE PREFERRED EMBODIMENT

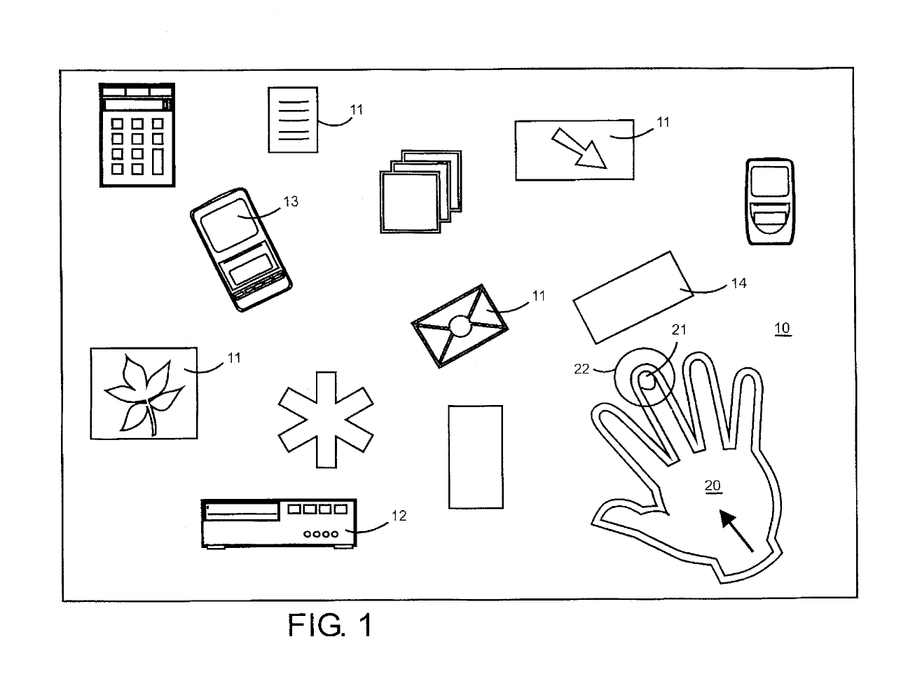

Referring to FIG. 1, there is shown a generalized diagram of a surface display computer screen surface illustrating the relationship of the user's hand with the fingerprint of an (id) finger with objects on the display screen. Surface display screen 10 includes a wide variety of objects 11 that may be accessed by users through the placement and movement of fingers of the hand 20 of a user touching or adjacent to screen. The objects 11 may be interactive documents, photographs, audio or video recordings, telephones or scales, among others. There may be two illustrative embodiments of user access to the surface display screen on which the present invention may be implemented:

A. Where the system needs to enable a great many people with access to the display I/O but have a smaller select group with access to secure functions.

B. Where the system is already limited to a group of identifiable users but still needs to provide individual users with the ability to separate and secure a selected set of displayed objects for a particular user.

Both embodiments require a database for storing (id) fingerprints of users of the surface display computer system. With respect to FIGS. 1 through 4, an implementation involving system B will now be described. As hand 20 addresses the screen 10, the fingerprint of the (id) finger 21, highlighted by circle 22, is sensed and compared to the stored (id) fingerprints. If there is a comparison match, access to the screen by all of the fingers of hand 20 is enabled. It should be noted that the (id) finger can be a specific finger, e.g. thumb or index finger. Alternatively, the (id) finger may be any finger on the hand. In the latter case, irrespective of where the fingers of hand 20 are placed on the screen, for example, a 36 or 40 diagonal inch screen, all fingers would then be compared for a match to a stored fingerprint. Upon a match of any finger on the hand anywhere on the screen, all of the fingers of hand 20 will be enabled to interact with display screen 10 and objects 11, 12, 13 and 14 on the surface display screen 20.

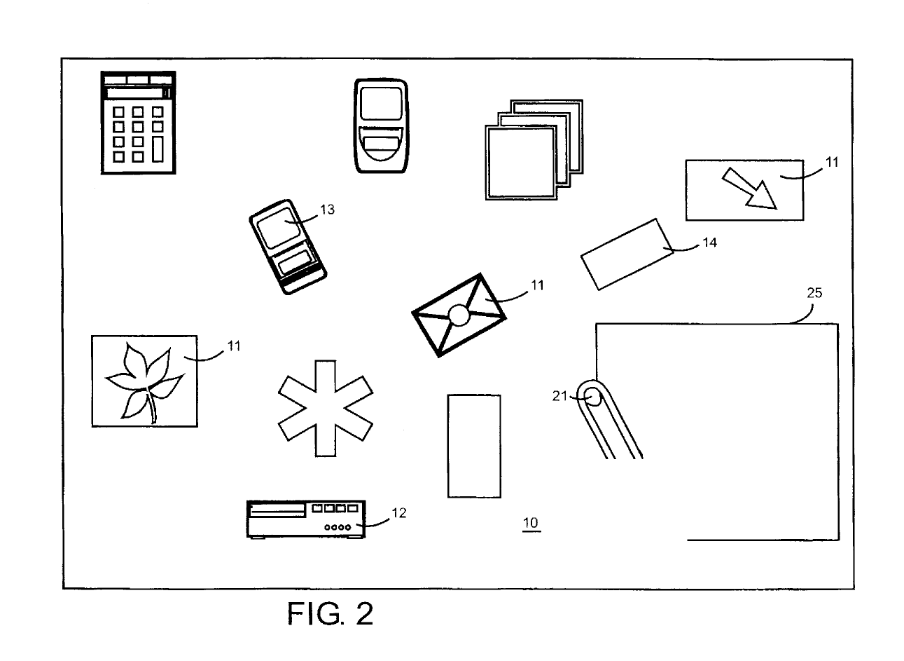

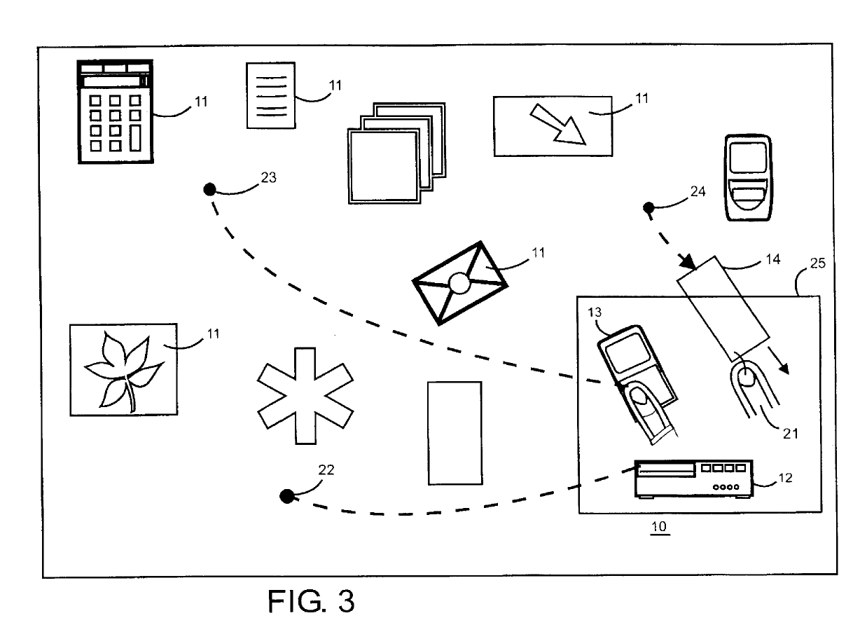

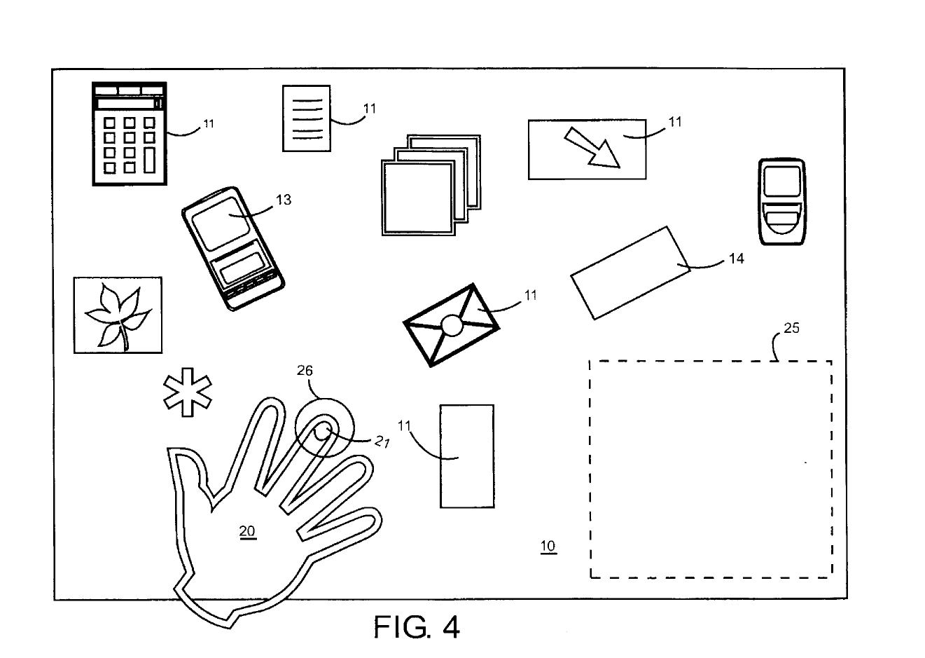

This advantage of the present invention will be further described with respect to FIG. 2. The interactively enabled finger 21 draws the boundary 25 of an enclosure. The user wishes to have exclusive use and control of a selected group of objects 12, 13 and 14. Accordingly, FIG. 3, the users finger drags and drops objects 12, 13 and 14 from their respective points of origin 22, 23 and 24 into enclosure 25. At this point, the user selects to store and use the enclosed objects exclusively. Upon such a user request, the enclosure 25, and its contained objects are stored, associated with the previously (id) fingerprint, hidden from the display screen, as indicated by dashed line 25, FIG. 4. Then, subsequently, when the user wishes to access the exclusive hidden enclosed objects, the user again places hand 20 adjacent to screen 10, FIG. 4. Upon a comparison match with the sensed fingerprint 26 of finger 21, the enclosure and its contained objects are again displayed for the exclusive use of the user. The user may have created several enclosures with sets of objects which have been hidden and stored. In the case of such multiple enclosures, upon the above identification of the user's fingerprint, the user is presented with a menu listing of his hidden enclosures from which the user may his desired enclosure.

Alternatively, with the implementation involving the above-described surface display embodiment A, the user's finger is not compared for a match to stored fingerprints until the completion of the enclosure and objects in FIG. 3. At this point the fingerprint is sensed and the enclosure will then be stored in association with the sensed fingerprint (id). After this point, the subsequent access and retrieval of the enclosed objects proceeds as described above.

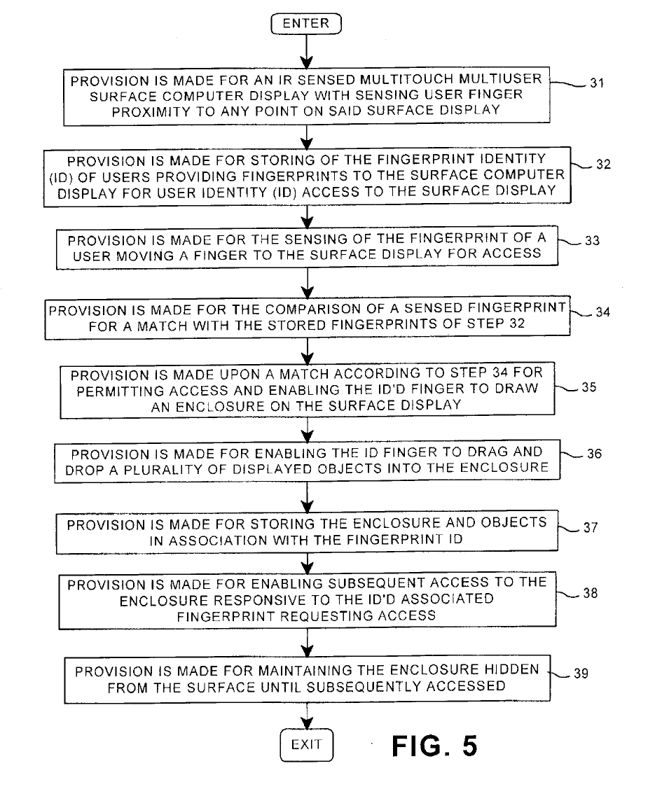

FIG. 5 is a generalized flowchart of an illustrative program set up to implement the present invention in accordance with the above-described embodiment B. There is provided an IR sensed multi-touch multiuser surface computer display based upon the sensing of the user's finger's proximity to any point on the display surface 31. Provision is made for the storing of the fingerprint (id) of users providing fingerprints to the display for user identity (id) access to the surface display 32. Provision is made for the sensing of a fingerprint of a user who moves a finger to the display surface for access 33. Provision is made, step 34, for a comparison of a sensed fingerprint for a match with the stored fingerprints of step 32. Provision is made, upon a match in step 34, for permitting access and enabling the (id)'d finger to draw an enclosure on the surface, step 35. Provision is made for enabling the (id)'d finger to drag and drop a plurality of objects in the display into the enclosure, step 36. Provision is made for storing the enclosure and objects in association with the fingerprint (id), step 37. Provision is made for enabling subsequent access to the enclosure responsive to the (id)'d associated fingerprint requested access, step 38. Provision is made for maintaining the enclosure hidden from the surface until subsequently accessed, step 39.

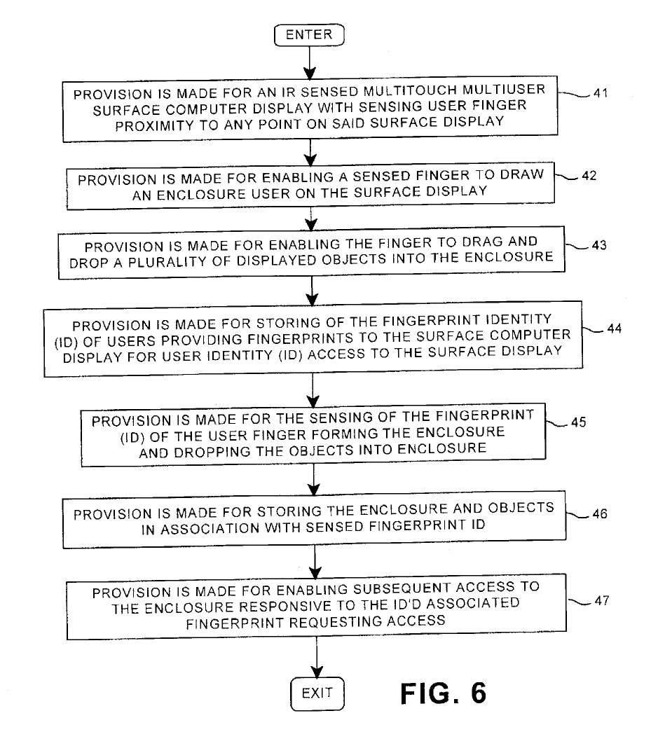

FIG. 6 is a generalized flowchart of another illustrative program set up to implement the present invention in accordance with the above-described embodiment A. There is provided an IR sensed multi-touch multiuser surface computer display based upon the sensing of the user's finger's proximity to any point on the display surface 41. Provision is made for enabling the finger of the user (before a fingerprint (id) is made) to draw an enclosure on the surface, step 42. Provision is made for enabling the finger to drag and drop a plurality of objects in the display into the enclosure, step 43. It should be noted that like the embodiment of FIG. 5, provision had been made for the storing of fingerprint identity (id) of users providing fingerprints to the display for user identity (id) access to the surface display 44. Thus, provision may be made for the sensing of the fingerprint (id) of the finger forming the enclosure and dropping the objects therein, step 45. Provision is made for storing the enclosure and objects in association with the sensed fingerprint (id), step 46. Provision is made for enabling subsequent access to the enclosure responsive to the (id)'d associated fingerprint requested access, step 47.

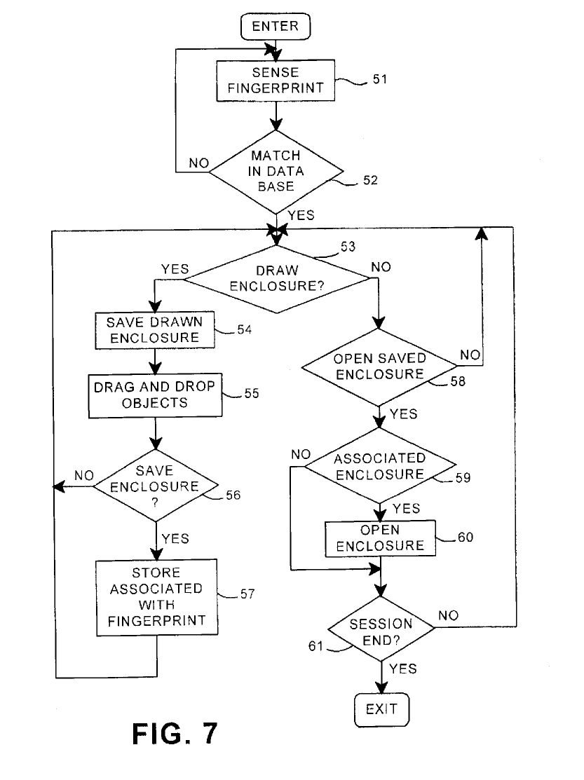

The running of the process set up in FIG. 5 will now be described with respect to the flowchart of FIG. 7. In a surface display computer, provision is made for sensing a fingerprint, step 51. A determination is then made as to whether the sensed fingerprint matches a fingerprint stored in the database of the system, step 52. If No, the process is returned to step 51. If Yes, a further determination is made as to whether a new enclosure is being drawn by the (id) finger, step 53. If Yes, the drawn enclosure is saved, step 54, and a user selected set of objects is dragged and dropped into the enclosure, step 55. A determination is then made, step 56, as to whether the user has chosen to save, i.e. store, the enclosure and objects for exclusive use. If Yes, the enclosure and contained objects are stored in association with the user fingerprint (id), step 57. If No, or after step 57, the process is returned to step 53.

If the determination in step 53 is No, i.e. an enclosure is not being drawn, then a determination is made, step 58, as to whether the user wishes to have access to a saved enclosure. If Yes, a determination is made, step 59, as to whether the sensed fingerprint is associated with a stored object enclosure. Then, if Yes, the enclosure is opened for user access, step 60. If the decision in step 59 is No, or after step 60, a determination may conveniently be made as to whether the surface display session is at an end, step 61. If Yes, the session is exited. If No, or if the determination in step 58 is No, the process is returned to step 53.

As will be appreciated by one skilled in the art, aspects of the present invention may be embodied as a system, method or computer program product. Accordingly, aspects of the present invention may take the form of an entirely hardware embodiment, an entirely software embodiment, including firmware, resident software, micro-code, etc.; or an embodiment combining software and hardware aspects that may all generally be referred to herein as a “circuit”, “module” or “system.” Furthermore, aspects of the present invention may take the form of a computer program product embodied in one or more computer readable mediums having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared or semiconductor system, apparatus or device, or any suitable combination of the foregoing. More specific examples (a non-exhaustive list) of the computer readable storage medium would include the following: an electrical connection having one or more wires, a portable computer diskette, a hard disk, a Random Access Memory (“RAM”), a Read Only Memory (“ROM”), an Erasable Programmable Read Only Memory (“EPROM” or Flash memory), an optical fiber, a portable compact disc read only memory (“CD-ROM”), an optical storage device, a magnetic storage device or any suitable combination of the foregoing. In the context of this document, a computer readable storage medium may be any tangible medium that can contain or store a program for use by or in connection with an instruction execution system, apparatus or device.

A computer readable medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate or transport a program for use by or in connection with an instruction execution system, apparatus or device.

Program code embodied on a computer readable medium may be transmitted using any appropriate medium, including, but not limited to, wireless, wire line, optical fiber cable, RF, etc., or any suitable combination the foregoing.

Computer program code for carrying out operations for aspects of the present invention may be written in any combination of one or more programming languages, including an object oriented programming language, such as Java, Smalltalk, C++ and the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the later scenario, the remote computer may be connected to the user's computer through any type of network, including a local area network (“LAN”) or a wide area network (“WAN”), or the connection may be made to an external computer (for example, through the Internet, using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer or other programmable data processing apparatus to produce a machine, such that instructions, which execute via the processor of the computer or other programmable data processing apparatus, create means for implementing the functions/acts specified flowchart and/or block diagram block or blocks.

These computer program instructions may also be stored in a computer readable medium that can direct a computer, other programmable data processing apparatus or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagram in the Figures illustrate the architecture, functionality and operations of possible implementations of systems, methods and computer program products according to various embodiments of the present invention. In this regard, each block in the flowchart or block diagrams may represent a module segment, or portion of code, which comprises one or more executable instructions for implementing the specified logical function(s). It should be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustrations can be implemented by special purpose hardware-based systems that perform the specified functions or acts, or combinations of special purpose hardware and computer instructions.

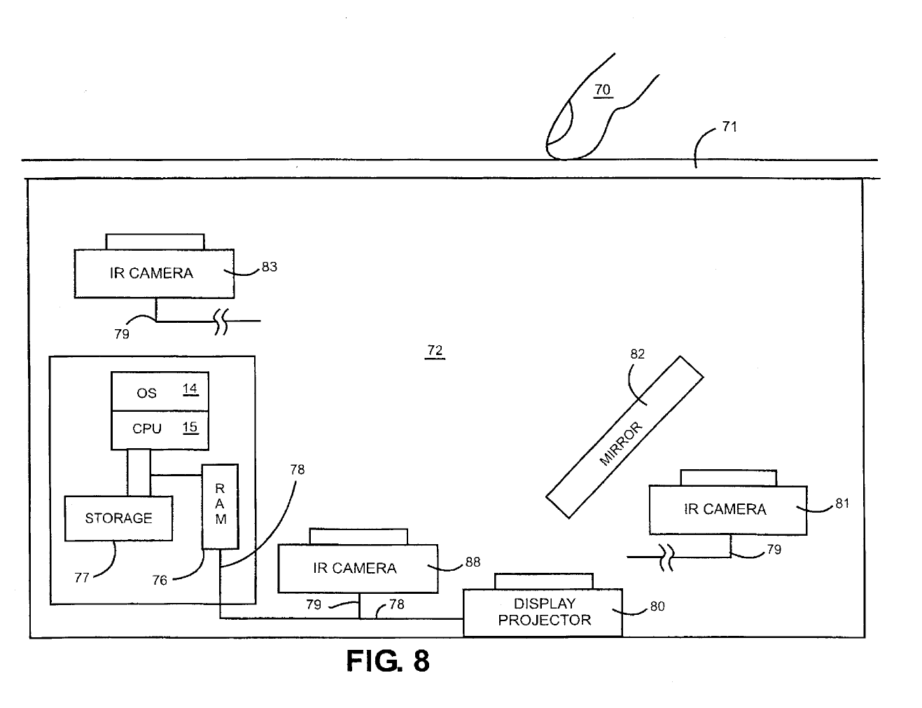

With respect to FIG. 8, there is shown an illustrative diagrammatic view of a surface display computer on which the present invention may be practiced. The surface display computer system 72 is controlled by computer 73 including computer processing unit (CPU) 75 on which operating system 74 controls the hardware components through programming in random access memory (RAM) that provides the operations of the present invention. The database, including the (id)'s fingerprints, is stored in disk storage 77 and moved into RAM as needed for the practice of the invention. Display projector 80 under control of the graphics engine in operating system through bus 78 projects the surface display 71 graphical user interface (GUI). Implements, such as finger 70 on the surface 71, have their images reflected onto IR Cameras 81, 83 and 88 that operate under CPU/OS control via buses 79. Mirror 82 enhances the reflection of light off the surface of finger 70 and the fingerprint image provided by finger surface ridges are captured by the IR Cameras.

Although certain preferred embodiments have been shown and described, it will be understood that many changes and modifications may be made therein without departing from the scope and intent of the appended claims.

What is claimed is:

1. In an optically sensed multi-touch input surface display computer system, a method for separating and securing the input of multiple users comprising:
storing at least one fingerprint of each of a plurality of users;
sensing the fingerprint of a finger of one user touching a surface display;
comparing said sensed fingerprint to said stored fingerprints for a match;
enabling the identified (id) finger of the matched fingerprint to access said surface display;
moving said (id) finger to draw an enclosure on said surface display;
moving said (id) finger to drag and drop a plurality of objects on said display into said enclosure;
storing said enclosure and plurality of objects; and
enabling subsequent access to said stored enclosure and plurality of objects only to said one user responsive to said fingerprint of said (id) finger touching said display.

2. The method of claim 1, wherein said fingerprint and said moving (id) finger are sensed by IR cameras.

3. The method of claim 2, wherein said fingerprint of said user's finger may be sensed at any location within the functional area of said surface display.

4. The method of claim 1 wherein;
a finger of a user is enabled to access the surface display prior to the sensing of the fingerprint of the finger;
said finger is enabled to draw said enclosure and to drag and drop said objects into said enclosure prior to the sensing of the fingerprint of the finger;
said user is enabled to select to exclusively store said enclosure and said plurality of objects;
said fingerprint of said user is sensed and stored in association with said enclosure responsive to said user selecting to exclusively store; and
said subsequent access to said stored enclosure is enabled to said user only upon a match of the fingerprint of a user finger seeking access to said stored associated fingerprint.

5. The method of claim 1, wherein said stored enclosure of objects is hidden from said surface display until accessed through said fingerprint match.

6. The method of claim 1, wherein responsive to said access to said enclosure through said fingerprint match, further enabling all of the fingers of said user to access the plurality of objects in said enclosure.

7. The method of claim 1, wherein a plurality of users are enabled to form a corresponding plurality of enclosures of objects respectively subsequently accessible to user by said fingerprint matches.

8. A computer controlled system for separating and securing the input of multiple users in an optically sensed multi-touch input surface display computer system, comprising:
a processor; and
a computer memory holding computer program instructions that when executed by the processor perform the method comprising:
storing at least one fingerprint of each of a plurality of users;
sensing the fingerprint of a finger of one user touching a surface display;
comparing said sensed fingerprint to said stored fingerprints for a match;
enabling the identified (id) finger of the matched fingerprint to access said surface display;
moving said (id) finger to draw an enclosure on said surface display;
moving said (id) finger to drag and drop a plurality of objects on said display into said enclosure;
storing said enclosure and plurality of objects; and
enabling subsequent access to said stored enclosure and plurality of objects only to said one user responsive to said fingerprint of said (id) finger touching said display.

9. The system of claim 8, wherein said fingerprint and said moving (id) finger are sensed by IR cameras.

10. The system of claim 9, wherein said fingerprint of said user's finger may be sensed at any location within the functional area of said surface display.

11. The system of claim 8, wherein in the performed method:
a finger of a user is enabled to access the surface display prior to the sensing of the fingerprint of the finger;
said finger is enabled to draw said enclosure and to drag and drop said objects into the enclosure prior to the sensing of the fingerprint of the finger;
said user is enabled to select to exclusively store said enclosure and said plurality of objects;
said fingerprint of said user is sensed and stored in association with said enclosure responsive to said user selecting to exclusively store; and
said subsequent access to said stored enclosure is enabled to said user only upon a match of the fingerprint of a user finger seeking access to said stored associated fingerprint.

12. The system of claim 8, wherein said stored enclosure of objects is hidden from said surface display until accessed through said fingerprint match.

13. The system of claim 8, wherein responsive to said access to said enclosure through said fingerprint match, said performed method further enables all of the fingers of said user to access the plurality of objects in said enclosure.

14. The system of claim 8, wherein a plurality of users are enabled to form a corresponding plurality of enclosures of objects respectively subsequently accessible to the user by said fingerprint matches.

15. A computer usable storage medium having stored thereon a computer readable program for separating and securing the input of multiple users in an optically sensed multi-touch input surface display computer system, wherein the computer readable program when executed on a computer causes the computer to:
store at least one fingerprint of each of a plurality of users;
sense the fingerprint of a finger of one user touching a surface display;
compare said sensed fingerprint to said stored fingerprints for a match;
enable the identified (id) finger of the matched fingerprint to access said surface display;
move said (id) finger to draw an enclosure on said surface display;
move said (id) finger to drag and drop a plurality of objects on said display into said enclosure;
store said enclosure and plurality of objects; and
enable subsequent access to said stored enclosure and plurality of objects only to said one user responsive to said fingerprint of said (id) finger touching said display.

16. The computer readable storage medium of claim 15, wherein said fingerprint and said moving (id) finger are sensed by IR cameras.

17. The computer readable storage medium of claim 16, wherein said fingerprint of said user's finger may be sensed at any location within the functional area of said surface display.

18. The computer readable storage medium of claim 15, wherein the computer readable program when executed further causes the computer to:
enable a finger of a user to access the surface display prior to the sensing of the fingerprint of the finger, wherein said finger is enabled to draw said enclosure and to drag and drop said objects into the enclosure prior to the sensing of the fingerprint of the finger;
enable said user to select to exclusively store said enclosure and said plurality of objects, wherein said fingerprint of said user finger is sensed and stored in association with said enclosure responsive to said user selecting to exclusively store; and
enable said subsequent access to said stored enclosure to said user only upon a match of the fingerprint of a user finger seeking access to said stored associated fingerprint.

19. The computer readable storage medium of claim 15, wherein said stored enclosure of objects is hidden from said surface display until accessed through said fingerprint match.

20. The computer readable storage medium of claim 15, wherein responsive to said access to said enclosure through said fingerprint match, the computer program when executed further enables all of the fingers of said user to access the plurality of objects in said enclosure.

21. The computer readable storage medium of claim 15, wherein the computer program when executed enables a plurality of users to form a corresponding plurality of enclosures of objects respectively subsequently accessible to said plurality of users by said fingerprint matches.
